(19) United States
(12) Patent Application Publication
(10) Pub. No.: US 2006/0162327 A1
(43) Pub. Date: Jul. 27, 2006

(54) Regulating device for a hydraulic system

(76) Inventor: Winfred Rub, Waldshut-Tiengen (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/527,726

(22) PCT Filed: Aug. 22, 2003
(86) PCT No.: PCT/IB03/03780

§ 371 Date: Mar. 14, 2005

(30) Foreign Application Priority Data
Oct. 7, 2002 (CH) 2002 1671/02

(51) Int. Cl. F16D 31/00

(52) U.S. Cl. 60/368

(57) ABSTRACT

Regulating apparatus for a hydraulic system having at least one valve controlling a consumer, the apparatus including a job computer, a bus connected to the job computer and to the valve, and at least one analog sensor producing a signal for controlling or regulating the consumer. An autonomous controlling and regulating element arranged between the bus and each valve includes a bus interface connected to the bus, a microcontroller connected to the bus interface and to the valve, and at least one analog-to-digital converter which is connected to the microcontroller and which can be connected to at least one analog sensor.

The invention is directed to a regulating device according to the preamble of claim 1.

Hydraulic systems comprise a hydraulic consumer and a regulating device by means of which the hydraulic consumer is controlled and regulated. The regulating device contains, for example, electrohydraulic valves, e.g., at least one directional valve, but also pilot valves. The regulating device also comprises a master computer, also called a job computer, which controls and regulates the hydraulic system. This job computer communicates with the individual parts of the hydraulic system by means of a bus. Therefore, the elements of the regulating device have a bus interface, e.g., an interface for a CAN bus. Since the values measured by sensors, e.g., for pressure, position and rotational speed, must also be taken into account in the regulation, sensors of this kind are also connected to the bus and accordingly likewise have a bus interface. Hydraulic systems of the type mentioned above can either be stationary or can be component parts of a vehicle.

In larger hydraulic systems in which very many elements are connected to the bus, there is intensive data traffic on the bus. The heavier the data traffic, that is, the greater the load on the bus, the slower the signal transmission. Therefore, problems can arise in time-critical controls in areas pertaining to security.

A regulating device of the type mentioned in the preamble of claim 1 is known from DE-A1-199 53 189. In this case, it is proposed that the master control unit be connected to the regulating valve via a first bus system, while sensors for the state variables of the regulating valve are connected to a second bus system. Accordingly, the data traffic is distributed to two separate bus systems so that the data traffic is reduced on each of the bus systems and security problems are avoided in time-critical control tasks.

A bus system is also a cost factor. Accordingly, a solution according to DE-A1-199 53 189 results in higher total costs. If very many sensors are connected in a regulating device, heavy data traffic also occurs on the second bus, which can again cause security problems in time-critical control tasks.

WO-A2-01/18763 discloses a device for transmitting control and/or sensor signals. An electronic control device and/or data receiving device is arranged between a pneumatic device containing two valves controlled by a microcontroller. The data exchange between the pneumatic device and the electronic control device and/or data receiving device is carried out over a pneumatic line. Accordingly, it is necessary to provide a bi-directional converter in both the pneumatic device and the electronic control device and/or data receiving device. Therefore, data signals and control signals are converted twice from an electric signal to a pressure, or vice versa. A solution of this kind is costly and possibly also not particularly precise because each signal conversion can mean that the signal has been corrupted. For conveying data or commands quickly, it is probably also not helpful that the pneumatic transmission medium is compressible. As a result of the two-fold signal conversion and the compressibility of the transmission medium, tolerance problems and, therefore, security problems are not unlikely.

WO-A1-01/77534 discloses a valve arrangement in which a plurality of valves are combined to form a subassembly. The valves are electrically actuated by a programmable control device. The control device can be programmed by means of a bus, but then operates predominantly autonomously. Therefore, external sensors and/or control signal generators which enable such autonomous operation can be connected to the valve arrangement. This reference does not show that a plurality of valve arrangements of this kind could be controllable by a master job computer.

It is the object of the invention to provide a regulating device in which security problems of the type mentioned above are prevented.

This object is met, according to the invention, through the features of claim 1. Advantageous further developments are indicated in the dependent claims.

An embodiment example of the invention will be described more fully in the following with reference to the drawings.

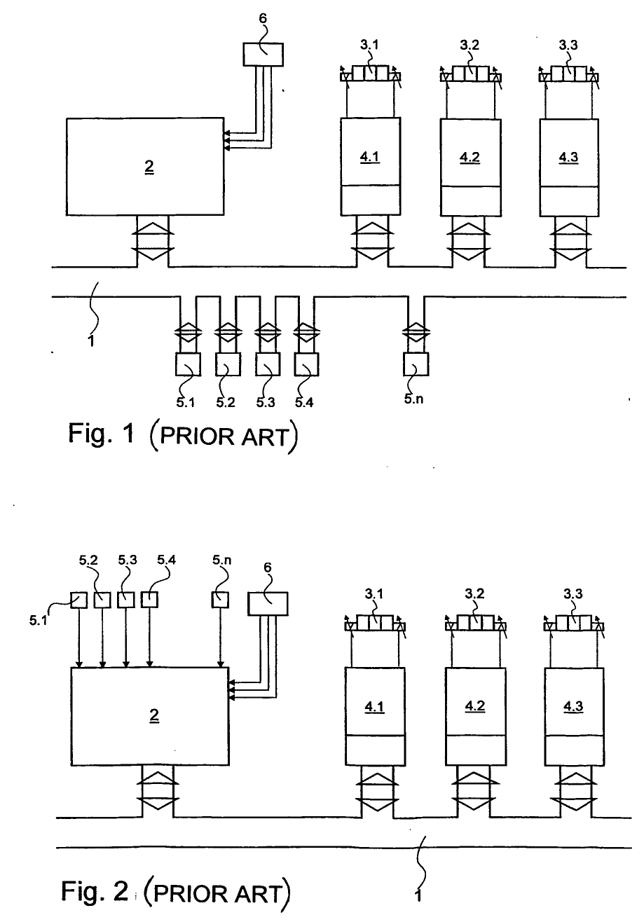

FIG. 1 shows a regulating device according to the prior art;

FIG. 2 shows another known prior art regulating device;

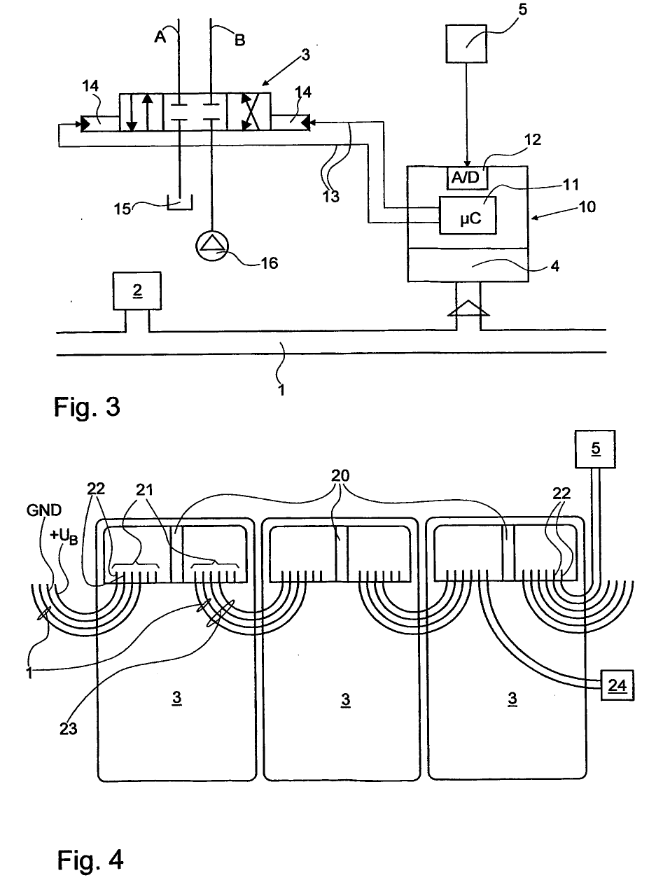

FIG. 3 is a diagram showing the regulating device according to the invention;

FIG. 4 is a schematic view with electric connections to three valves; and

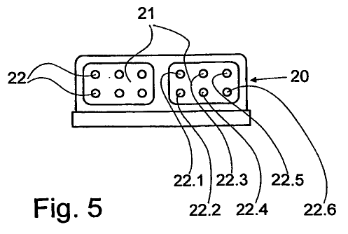

FIG. 5 shows a top view of a plug-in connection.

FIG. 1 shows a prior art device that differs from DE-A1-199 53 189. In this case, an individual bus 1 is provided which connects a job computer 2 to the valves 3 to be controlled. A first valve 3.1, a second valve 3.2 and a third valve 3.3 are shown. Each valve 3 is connected to the bus 1 by a bus interface 4. A first bus interface 4.1, a second bus interface 4.2 and a third bus interface 4.3 are shown in a corresponding manner.

A series of sensors 5, shown by way of example as sensors 5.1, 5.2, 5.3, 5.4 and 5.n, is also connected to the bus 1. A reference value generator 6 is connected to the job computer 2 directly by an analog data line.

In an arrangement of the type mentioned above, although its construction is very simple, very heavy data traffic occurs on the bus 1 resulting in the problems mentioned in the introduction. The above-cited DE-A1-199 53 189 is an advantageous further development of this prior art in that it provides two separate bus systems.

FIG. 2 shows another known prior art device. In order to maintain light data traffic on the bus 1, the sensors 5, again shown by way of example as sensors 5.1, 5.2, 5.3, 5.4 and 5.n, are connected to the job computer 2 by analog data lines. This solution is disadvantageous in that the number of data lines is very great and the individual data lines can also have a considerable length because sensors 5 are, for example, associated with the individual valves 3 and arranged at the latter. While a solution of this kind prevents uncontrollably heavy data traffic on the bus 1, it is extremely complicated with respect to wiring. The risk of wiring errors is especially great, which makes it expensive to put into operation. Another risk is that the data lines leading to the sensors 5 can be influenced by electromagnetic interference fields which also has a disadvantageous effect on security.

FIG. 3 shows an embodiment example of the solution according to the invention. The valve 3 is shown by a hydraulic symbol. The bus 1 to which the job computer 2 and the valve 3 are connected is also shown. According to the invention, however, the valve 3 is not connected directly to the bus interface 4, but rather to a controlling and regulating element 10 that is outfitted with the bus interface 4. The controlling and regulating element 10 has a microcontroller 11 which is connected to the bus interface 4. Further, the controlling and regulating element 10 has at least one analog-to-digital converter 12 to which the sensor 5 of a consumer, not shown, is connected on the one hand and which is connected to the microcontroller 11 on the other hand. Control lines 13 lead from the microcontroller 11 to hydraulic drives 14 of the valve 3.

The consumer, not shown, can be, for example, a drive cylinder or a hydromotor which is connected in a known manner to working connections A and B of the valve 3. The sensor 5 is associated with the consumer. When the consumer is a hydromotor, the sensor 5 detects its rotational speed, for example. When the consumer is a drive cylinder, the sensor 5 detects its position, for example. Depending on the application, the sensor 5 can also detect a pressure, a temperature or a flow rate which is associated with the state of or the action of the consumer. The controlling and regulating element 10 can also have two or more analog-to-digital converters 12 when a plurality of sensors 5 are associated with the consumer.

It can be seen from the hydraulic symbol of the valve 3 that it is a directional valve which conventionally has a connection to a tank 15 and to a pump 16. According to the invention, between the bus interface 4 and the valve 3 to be controlled there is arranged an autonomous controlling and regulating element 10 with the microcontroller 11 which processes the signal of the analog sensor 5. This solution according to the invention has the advantage over the previously known prior art that the amount of data on the bus 1 is greatly reduced because the signals of the sensor 5 do not load the bus 1. Therefore, a second bus system according to DE-A1-199 53 189 is not required, which brings substantial advantages in terms of cost. It is extremely significant that the job computer 2 is also appreciably relieved as a result of the solution according to the invention because this job computer 2 does not have to process the signals of the sensors 5 at all, since these signals are processed within the controlling and regulating element 10 by the microcontroller 11. The job computer 2 therefore also does not send any actuating commands for the valve 3 via the bus 1, which also appreciably reduces the bus load.

Because the sensor 5 is connected directly to the controlling and regulating element 10, the controlling and regulating element 10 with the microcontroller 11 can control and regulate the valve 3 autonomously based on the signals of the sensor 5. That is, the controlling or regulating algorithm is implicit in the microcontroller 11. This limits the operation of the job computer 2 to conveying reference values for the consumer, as reference variables, to the controlling and regulating element 10 via the bus 1.

Since every valve 3 is controlled and regulated autonomously by the associated controlling and regulating element 10, the job computer 2 is relieved and the data traffic on the bus 1 is minimized. This is particularly advantageous in time-critical controls in areas pertaining to security.

Due to the fact that, according to the invention, the signal of the sensor 5 is processed in the controlling and regulating element 10 instead of in the job computer 2, the control or regulation is substantially faster because there is no longer any need for multiple signal conversions in the bus interfaces 4. No delays occur due to intensive traffic on the bus 1.

It is advantageous when the controlling and regulating element 10 is arranged directly at the associated valve 3. The control lines 13 are then very short so that the risk of influence by electromagnetic interference is very small, which increases security.

FIG. 4 shows a schematic view of three valves 3. Each of the valves 3 has a plug-in unit 20 which is advantageously formed of two identical plug-in connection configurations 21. Each of these plug-in connection configurations 21 has six contacts 22, two of which serve for the connection to the bus 1, another two forming the power supply with connections +U_{B} and GND, while two are provided for the connection to the sensor 5.

Within the framework of the invention, it is possible that the sensor 5 is a two-conductor sensor which can accordingly be connected to two contacts 22. Alternatively, a sensor 5 can also be connected to ground GND on one side so that an individual contact 22 is sufficient for connecting to the plug-in connection configuration 21. In a case such as this, two sensors 5 formed as single-conductor sensors can be connected to one of the plug-in connection configurations 21. Since the plug-in unit 20 has two identical plug-in connection configurations 21, up to four sensors 5 can be connected to a valve 3, which is sufficient for all conceivable applications.

Since two plug-in connection configurations 21 are provided at each valve 3, the bus 1 and the power supply between the individual valves 3 can be looped by a bridge 23 comprising four lines. Wiring errors are prevented in this way.

In one of the valves 3 shown in the drawing, namely, in the valve at the far right-hand side, another advantageous construction is shown. It can be seen that an analog transmitter 24 can be connected to two contacts 22 of one of the plug-in connection configurations 21 of the plug-in unit 20. Therefore, it is possible, for example, to control a valve 3 directly from this transmitter 24.

In order to realize the possibilities described above, the known prior art digital controls provide sufficiently known possibilities for configuring devices with a microcontroller 11, for which programming devices are used.

FIG. 5 shows a top view of the plug-in unit 20. As was already mentioned, it comprises two identical plug-in connection configurations 21, each with six contacts 22. In the plug-in connection configuration 21 on the right-hand side, the contacts 22 are designated by 22.1, 22.2, 22.3, 22.4, 22.5 and 22.6 to distinguish between the individual contacts 22. This applies also to the plug-in connection configuration 21 shown at the left-hand side. The contact 22.1 supplies the operating voltage +U_{B}, for example, while contact 22.2 leads to reference ground GND. Accordingly, the two contacts 22.1 and 22.2 together form the power supply. Contacts 22.3 and 22.4 are the contacts to which the two data lines of the bus 1 can be connected. Contacts 22.5 and 22.6 are used for the connection of analog sensors 5 or of the analog transmitter 24. The configuration will determine what is connected to contacts 22.5 and 22.6 of the two plug-in connection configurations 21. In both plug-in connection configurations 21, the allocation of the contacts 22.1 to 22.6, per se, is identical, but the configuration can determine whether contacts 22.5 and 22.6 are to be connected to a sensor 5 constructed as a two-conductor sensor, or to two sensors 5 constructed as single-conductor sensors, or to the transmitter 24.

Further, the programming of the microcontroller 11 can determine how the signals at the contacts 22.5 and 22.6 of the two plug-in connection configurations 21 will be processed in the microcontroller 11. For example, it can be determined by programming whether the signals are actual values originating from a sensor 5 or reference values originating from a transmitter 24. At the same time, it can also be determined by programming whether or not one of the values should have priority over another value, which is important, for example, when two sensors 5 are connected. As an alternative to determining a priority in this way, it is also possible to combine the signals of two sensors 5, e.g., by summing or differentiating.

It can also be determined by programming the microcontroller 11 whether or not the signal of a transmitter acting on the job computer 2 (FIG. 3), which signal arrives via the bus 1, should have priority over a transmitter 24 connected to one of the plug-in connection configurations 21.

It is also important that the programming of the microcontroller 11 makes it possible to determine whether or not the signals of a transmitter 24 connected to one of the plug-in connection configurations 21 and of a sensor 5 are to be conveyed by the bus 1 to the job computer 2. In this way, it is possible to convey the data to the job computer 2 by the bus 1, although neither the transmitter 24 nor the sensor 5 has its own connection to the bus 1.

By outfitting every valve 3 with a microcontroller 11 which also influences the data traffic via the bus 1, it is possible to adapt the individual valves 3 to any control tasks in an optimal manner.

1-8. (canceled)

9. Regulating apparatus for a hydraulic system comprising at least one valve controlling a consumer, the apparatus comprising:
a job computer;
a bus connected to the job computer and each said valve;
at least one analog sensor producing a signal for controlling or regulating the consumer; and
an autonomous controlling and regulating element arranged between the bus and each said valve, each said element comprising a bus interface connected to the bus, a microcontroller connected to the bus interface and to the valve, and at least one analog-to-digital converter which is connected to the microcontroller and which can be connected to at least one analog sensor.

10. The regulating apparatus of claim 9 wherein the controlling and regulating unit is structurally combined with the valve.

11. The regulating apparatus of claim 10 wherein each said valve comprises a plug-in unit by which the controlling and regulating element can be connected to the bus and to the sensors and to a power supply.

12. The regulating apparatus of claim 11 wherein each said plug-in unit comprises two identical plug-in configurations, each said configuration comprising a connection for the bus, the power supply, and at least one sensor.

13. The regulating apparatus of claim 12 wherein each said connection comprises six contacts, two of said contacts serving for connection to at least one analog sensor.

14. The regulating apparatus of claim 13 wherein said two of said contacts can be connected to a single two-conductor analog sensor.

15. The regulating apparatus of claim 13 wherein said two of said contacts can be connected to two said analog sensors which are also connected to ground.

16. The regulating apparatus of claim 12 wherein said two of said contacts can be connected to an analog transmitter.
